(19) United States
(12) Patent Application Publication
(10) Pub. No.: US 2026/0360324 A1
(43) Pub. Date: Nov. 12, 2026

(54) METHODS FOR REDUCING BLOOMING ARTIFACTS IN IMAGES RENDERED ON COLOR FILTER ARRAY BASED ELECTROPHORETIC DISPLAYS

(71) Applicant: E INK CORPORATION, Billerica, MA (US)

(72) Inventors: Alishan PREMANI, Somerville, MA (US); Sarah PAYDAVOSI, Winchester, MA (US)

(21) Appl. No.: 19/557,809

(22) Filed: Mar. 5, 2026

Related U.S. Application Data
(60) Provisional application No. 63/771,451, filed on Mar. 13, 2025.

(51) Int. Cl. G09G 3/34

(52) U.S. Cl. CPC G09G 3/344; G09G 2300/0426; G09G 2310/06; G09G 2320/0242; G09G 2320/0257

(57) ABSTRACT

Color filter array (CFA) based electrophoretic displays and methods for rendering images on such displays are disclosed to reduce blooming artifacts and improve color uniformity, including in pen writing and erasing operations. In rendering an image, the method features determining the strength of any fringe field applied to each non-updating display pixel resulting from updating of adjacent display pixels, and selecting and applying a top-off waveform to the non-updating display pixel having a strength generally commensurate with the strength of the fringe field to reduce blooming artifacts from the fringe field.

### CROSS REFERENCE TO RELATED APPLICATION(S)

This application claims priority from U.S. Provisional Patent Application No. 63/771,451 filed on Mar. 13, 2025 entitled METHODS FOR REDUCING BLOOMING ARTIFACTS IN IMAGES RENDERED ON COLOR FILTER ARRAY BASED ELECTROPHORETIC DISPLAYS, which is hereby incorporated by reference in its entirety.

### TECHNICAL FIELD OF THE INVENTION

This application relates generally to color filter array (CFA) based electrophoretic displays and methods for rendering images on such displays to reduce blooming artifacts and improve color uniformity, including in pen writing and erasing operations.

### BACKGROUND

An electrophoretic display (EPD) changes color by modifying the position of charged colored particles relative to a light-transmissive viewing surface. Such EPDs are typically referred to as “electronic paper” or “ePaper” because the resulting display has high contrast and is sunlight-readable, much like ink on paper. In the simplest sense, an EPD only requires a light-transmissive electrode at the viewing surface, a back electrode, and an electrophoretic medium including one or more types of charged colored particles. If the back electrode includes controllable regions (pixels)—either segmented electrodes or an active matrix of pixel electrodes controlled by transistors—a pattern can be made to appear electronically at the viewing surface. The pattern can be, e.g., the text to a book.

A variety of color options commercially available for EPDs, including four-color displays (black, white, red, yellow; red, white, yellow, semi-transparent blue; cyan, yellow, magenta, white). Color EPDs can also be achieved using CFAs disposed above or below a layer of electrophoretic display materials, e.g., a layer of microcapsules with black and white oppositely-charged particles that change position relative to a viewer due to an applied electric field. See, e.g., U.S. Pat. Nos. 8,098,418 and 10,444,592. However, EPDs incorporating CFAs suffer from loss of color spatial resolution due to the presence of subpixels. See, e.g., FIGS. 1D and 1E of the instant application, illustrating that a “pixel” (dashed bounding box) of a CFA-enabled display typically comprises at least three individually-controllable subpixels. Traditionally, CFA displays have red, green, and blue filters, however other complimentary sets of colors can also be used. Because of the subpixels, if one of the primary colors is to be shown for a pixel of the display, the pixel has only one third or less (less because there is filling between subpixels) of the display area to be utilized for showing that color. The other subpixels are dark to increase the chromaticity of the desired color.

Of course, most color images require more than red, green, blue, black, and white pixels. While it is possible to approximate some colors (e.g., purple) with mixes of subpixels, a more common method is to dither the colors across the pixels in an image to achieve the desired color and shading. However, when dithering is used to increase the available colors in an EPD, the dithered subpixels involved in the dithering process may be subject to unwanted cross-talk with nearby subpixels, which can result in dithered colors looking “off”. See, e.g., U.S. Pat. No. 11,869,451. Additional problems arise when, e.g., only part of the image is updated (a.k.a. partial update), which can also result in colors on the non-updated edges on the border of the updated pixels looking “off.” See, e.g., U.S. Pat. No. 11,557,260.

For the most part, electrophoretic media, such as described above, are designed to be driven with low voltage square waves, such as produced by a driver circuit from a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electrophoretic media are driven directly via an isolated electrode (e.g., segmented electrode) the driving pulses are delivered as square waves, having an amplitude and a time width. See, e.g., U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

When the electrophoretic medium includes multiple types of particles with the same charge polarity but different charge magnitudes, the final position of a given set of particles (and the optical state) is typically controlled with a sequence of positive and negative voltage impulses. For example, all of the positive particles may be driven to the viewing surface and then a combination of negative and positive voltages serves to disaggregate the collection of positive particles and drive the unwanted positive particles away from the view surface so that only the desired particle sets are viewed. However, driving methods that require multiple positive and negative pulses often result in color transitions that are visibly jarring to a user, also known as “flashy updates.” It is possible to decrease the amount of flash by making the waveforms longer and using smaller voltage steps, however such waveforms are not suitable for applications such as page turning or pen (stylus) writing. In such applications, a user expects a nearly instantaneous response by the display and high contrast between first and second optical states. (See, e.g., U.S. Patent Publication No. 2022/0262323 for a description of long gradual waveforms.) Historically, it has been difficult to achieve a short, low flash, low latency color waveform for such multi-particle systems.

Electrophoretic and other electro-optic displays typically include a backplane having a plurality of pixel electrodes, each of which defines one pixel of the display. Each pixel electrode is typically disposed in a rectangular array of pixel electrodes and each pixel electrode is controlled with a thin-film transistor (TFT). The TFTs are updated in a row-by-row fashion. Conventionally, a single common electrode extending over a large number of pixels, and normally the whole display is disposed on the opposed side of the electro-optic medium. The individual pixel electrodes may be driven directly (i.e., a separate conductor may be provided to each pixel electrode) or the pixel electrodes may be driven in an active matrix manner that will be familiar to those skilled in backplane technology. Since adjacent pixel electrodes will often be at different voltages, they are separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media, the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, e.g., a desired white pixel may include various shades of gray along the edges, a.k.a., “edge ghosting”. Furthermore depending upon the type of display, i.e., black/white, color, black/white with color filter, the results of the edge ghosting can range from annoying to debilitating. In some cases, asymmetric blooming may contribute to edge ghosting.

Much of the discussion below will focus on methods for driving one or more pixel electrodes of an electro-optic display through a transition from a first optical (i.e., color) state to a second optical state (which may or may not be different from the initial optical state). The term “waveform” is used to denote the entire voltage against time curve used to effect the transition from one specific first color state to a specific second color state. Typically, such a waveform will comprise a plurality of waveform elements; where these elements are essentially rectangular (V x t) voltage pulses (i.e., where a given element comprises application of a constant voltage for a period of time); the elements may be called “pulses” or “drive pulses”. The term “drive scheme” denotes a set of waveforms sufficient to effect all possible transitions between gray levels for a specific display. A display may make use of more than one drive scheme; e.g., the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible to use more than one drive scheme simultaneously in different areas of the same display, and a set of drive schemes used in this manner may be referred to as “a set of simultaneous drive schemes.”

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, e.g., at least four times, the minimum duration of the addressing pulse required to change the state of the display element. It is shown in U.S. Pat. No. 7,170,670 that some particle-based EPDs capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of EPDs allows for massive power savings over traditional “always on” displays such as LCD and LED, the bistability can lead to image retention between updates, a.k.a. “ghosts”.

A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see, e.g., U.S. Pat. No. 7,002,728;
(b) Capsules, binders and encapsulation processes; see, e.g., U.S. Pat. Nos. 6,922,276 and 7,411,719;
(c) Microcell structures, wall materials, and methods of forming microcells; see, e.g., U.S. Pat. Nos. 7,072,095 and 9,279,906;
(d) Methods for filling and sealing microcells; see, e.g., U.S. Pat. No. 7,715,088 and U.S. Patent Application Publication No. 2002/0188053;
(e) Films and sub-assemblies containing electro-optic materials; see, e.g., U.S. Pat. Nos. 6,982,178 and 7,839,564;
(f) Backplanes, adhesive layers and other auxiliary layers and methods used in displays; see, e.g., U.S. Pat. Nos. 7,116,318 and 7,535,624;
(g) Color formation and color adjustment; see, e.g., U.S. Pat. Nos. 7,075,502 and 7,839,564;
(h) Methods for driving displays; see, e.g., U.S. Pat. Nos. 7,012,600 and 7,453,445;
(i) Applications of displays; see, e.g., U.S. Pat. Nos. 7,312,784 and 8,009,348; and
(j) Non-electrophoretic displays, as described in U.S. Pat. No. 6,241,921 and U.S. Patent Applications Publication No. 2015/0277160; and applications of encapsulation and microcell technology other than displays; see, e.g., U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed EPD, in which the electrophoretic medium comprises a plurality of discrete droplets of an electrophoretic fluid and a continuous phase of a polymeric material, and that the discrete droplets of electrophoretic fluid within such a polymer-dispersed EPD may be regarded as capsules or microcapsules even though no discrete capsule membrane is associated with each individual droplet; see e.g., U.S. Pat. No. 6,866,760. Accordingly, for purposes of the present application, such polymer-dispersed electrophoretic media are regarded as sub-species of encapsulated electrophoretic media.

A related type of EPD is a so-called microcell EPD. In a microcell EPD, the charged particles and the fluid are not encapsulated within microcapsules but instead are retained within a plurality of cavities formed within a carrier medium, typically a polymeric film. See, e.g., U.S. Patents Nos. 6,672,921 and 6,788,449.

An encapsulated EPD typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Patent No. 7,339,715); and other similar techniques.) Thus, the resulting display can be flexible. Further, because the display medium can be printed (using a variety of methods), the display itself can be made inexpensively. Additionally, as described in U.S. Patent Application Publication No. 2021/0132459, encapsulated electrophoretic media can be incorporated into non-planar surfaces that are, in turn, incorporated into everyday objects. As a result, surfaces of products, building materials, etc. can be engineered to change color when a suitable electric field is supplied.

### SUMMARY

Disclosed herein in accordance with one or more embodiments of the invention are CFA based electrophoretic displays and methods for rendering images on such displays to reduce blooming artifacts. The CFA based electrophoretic display includes an electrophoretic medium layer superposed on a backplane array of electrodes. Each of the electrodes is independently addressable to apply driving waveforms to an adjacent portion of the electrophoretic medium layer to drive such portion of the electrophoretic medium layer between a first substantially white optical state and a second substantially black optical state thereby forming an array of black and white display pixels in the electrophoretic medium. The display also includes a CFA superposed on the electrophoretic medium layer. The CFA comprising an array of CFA pixels, each of which comprises at least three CFA subpixels. Each of the CFA subpixels has a different color and is in registered alignment with a different one of the display pixels such that the color of any CFA subpixel is visible to a viewer when the display pixel in registered alignment with that CFA subpixel is in the substantially white optical state. The color of any CFA subpixel is not visible to the viewer when the display pixel in registered alignment with that CFA subpixel is in a substantially black optical state or is less visible to the viewer than the color of a CFA subpixel in registered alignment with a display pixel in the substantially white optical state. The method includes the steps of: (a) rendering a first image on the display wherein each of the display pixels have a selected optical state; and (b) rendering a subsequent second image on the display in which a first subset of the display pixels has the same optical states as in the first image and a second subset of the display pixels has different optical states than in the first image by (i) applying a selected direct update waveform to each display pixel in the second subset of display pixels to update the optical state of the display pixel; (ii) determining the strength of any fringe field applied to each display pixel in the first subset of display pixels resulting from updating of adjacent display pixels in the second subset of display pixels, and selecting and applying a top-off waveform to the display pixel having a strength commensurate with the strength of the fringe field to reduce blooming artifacts from the fringe field. Steps (a) and (b) may be performed by a controller and/or a processor configured to drive the display pixels to desired optical states.

A CFA based electrophoretic display in accordance with one or more embodiments of the invention comprises an electrophoretic medium layer having a viewing side for facing a viewer; a light-transmissive electrode on the viewing side of the electrophoretic medium layer; and a backplane array of electrodes superposed on a side of the electrophoretic medium layer opposite the viewing side. Each of the electrodes is independently addressable to apply driving waveforms to an adjacent portion of the electrophoretic medium layer to drive such portion of the electrophoretic medium layer between a first substantially white optical state and a second substantially black optical state thereby forming an array of black and white display pixels in the electrophoretic medium. The display also includes a CFA superposed on the electrophoretic medium layer. The CFA comprises an array of CFA pixels, each of which comprises at least three CFA subpixels. Each of the CFA subpixels has a different color and is in registered alignment with a different one of the display pixels such that the color of any CFA subpixel is visible to a viewer when the display pixel in registered alignment with that CFA subpixel is in the substantially white optical state. The color of any CFA subpixel is not visible or less visible to the viewer when the display pixel in registered alignment with that CFA subpixel is in a substantially black optical state. The display also includes a control system coupled to the light-transmissive electrode and the backplane array of electrodes. The control system includes a controller and/or a processor configured to: (a) render a first image on the display wherein each of the display pixels have a selected optical state; and (b) render a subsequent second image on the display in which a first subset of the display pixels has the same optical states as in the first image and a second subset of the display pixels has different optical states than in the first image by (i) applying a selected direct update waveform to each display pixel in the second subset of display pixels to update the optical state of the display pixel; (ii) determining the strength of any fringe field applied to each display pixel in the first subset of display pixels resulting from updating of adjacent display pixels in the second subset of display pixels, and selecting and applying a top-off waveform to the display pixel having a strength commensurate with the strength of the fringe field to reduce blooming artifacts from the fringe field.

In one or more embodiments, the step of determining a strength of any fringe field applied to each display pixel in the first subset of display pixels comprises determining the number of cardinal neighboring display pixels in the second subset of display pixels having a different optical state in the second image than the display pixel. As used herein, a “cardinal neighbor” is a pixel electrode immediately adjacent to the pixel electrode of interest. The cardinal neighbors can be described as the cardinal positions on a compass, i.e., north, south, east, west, northeast, southeast, southwest, northwest. The fringe field effects of adjacent north, south, east, and west pixel electrodes are greater because there is a greater common linear distance in common with the pixel electrode of interest.

In one or more embodiments, step (ii) comprises applying a selected top-off waveform to each display pixel in the first subset of display pixels that has at least one cardinal neighboring display pixel in the second subset of display pixels having a different optical state in the second image than the display pixel to reduce blooming artifacts in the display pixel; and applying no waveform to remaining display pixels in the first subset of display pixels.

In one or more embodiments, each direct update waveform comprises a given number of voltage pulses having a given amplitude, and wherein each top-off waveform has the same given amplitude and a smaller number of voltage pulses than the given number of voltage pulses of the direct update waveforms.

In one or more embodiments, the images are rendered in response to a stylus writing or erasing input to the electrophoretic display.

In one or more embodiments, the method further comprises retrieving the direct update waveforms and the top-off waveforms from one or more lookup tables stored in a memory.

In one or more embodiments, steps (i) and (ii) are completed in less than 500 ms, preferably less than 200 ms, preferably less than 100 ms.

In one or more embodiments, the colors of the CFA subpixels include red, green, and blue.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1A is a simplified representative cross-section view of a four-particle EPD in which the electrophoretic medium is encapsulated in microcapsules.

FIG. 1B is a simplified representative cross-section view of a four-particle EPD in which the electrophoretic medium is encapsulated in microcells.

FIG. 1C is a simplified representative cross-section view of an EPD, including an electrophoretic layer of oppositely charged black and white particles, and a CFA disposed between the electrophoretic layer and the viewer.

FIG. 1D is an exemplary RBGW CFA pattern that can be used with a CFA-based color EPD. The dashed line defines a “pixel” for the purposes of defining a pixel in an image. Each pixel of the RGBW CFA includes an independently controllable red, green, and blue partially-transmissive filter portion known as a “subpixel”. A clear (i.e., white) subpixel helps to improve white and light colors in an image. Below each subpixel is an independently-controllable pixel electrode of the type shown in FIG. 2B.

FIG. 1E is an exemplary RBG color filter array pattern that can be used with a CFA-based color EPD. The dashed line defines a pixel for the purposes of defining a pixel in an image. Each pixel of the RGB CFA includes an independently controllable red, green, and blue partially-transmissive filter portion, known as a subpixel; a portion around each subpixel is clear (a.k.a., partial fill CFA) in order to improve white and light colors in an image, but with higher overall resolution that in FIG. 1D. Below each subpixel is an independently-controllable pixel electrode of the type shown in FIG. 2B.

FIG. 2A illustrates an exemplary equivalent circuit of a single pixel of an EPD that uses an active matrix backplane with a storage capacitor.

FIG. 2B illustrates an exemplary equivalent circuit of a simplified EPD, allowing driving in a row-column format.

FIG. 3 is a block diagram illustrating an exemplary EPD that includes a display module, a processor, memory, one or more power supplies, and a controller. The EPD may also include sensors to allow the EPD to adjust operational parameters based upon the ambient environment, e.g., temperature and illumination.

FIG. 4 illustrates fringe fields that cause blooming when one pixel (left side of figure) of an EPD is driven with a non-zero voltage (e.g., 24V) and a neighboring pixel (right side of figure) is driven with 0V.

FIG. 5 shows an example of direct update waveforms (applied to updating pixel electrodes) of an EPD in combination with empty black to black or white to white transitions comprising a 0V drive (applied to non-updating pixel electrodes).

FIG. 6 shows non-uniform color pen writing and ineffective erasing as a result of blooming artifacts using known writing and erasing processes.

FIG. 7 is a flowchart generally illustrating an exemplary process for reducing blooming artifacts in EPD images in accordance with one or more embodiments of the invention.

FIG. 8 shows one example of a set of top-off waveforms or transitions that may be applied to non-updating pixels to reduce blooming effects in accordance with one or more embodiments of the invention.

FIG. 9 provides three examples illustrating how top-off waveforms can be selected and applied to reduce blooming artifacts in accordance with one or more embodiments.

FIG. 10 illustrates the results of testing for writing color uniformity when writing using direct update drive schemes in accordance with one or more embodiments of the invention compared to prior art driving schemes.

FIG. 11 illustrates the results of testing for ghosting after erasing when using direct update drive schemes in accordance with one or more embodiments of the invention compared to prior art driving schemes.

FIG. 12 shows an example of alternate direct update drive schemes in accordance with one or more further embodiments of the invention.

### DETAILED DESCRIPTION

Various embodiments of the invention relate to CFA based electrophoretic displays and methods for rendering images on such displays to reduce blooming artifacts and improve color uniformity, including in pen writing and erasing operations.

Methods for fabricating an EPD including two, three, four (or more) particles have been discussed in the prior art. The electrophoretic fluid may be encapsulated in microcapsules or incorporated into microcell structures that are thereafter sealed with a polymeric layer. The microcapsule or microcell layers may be coated or laminated to a plastic substrate or film bearing a transparent coating of an electrically conductive material. Alternatively, the microcapsules may be coated onto a light transmissive substrate or other electrode material using spraying techniques. (See, e.g., U.S. Pat. No. 9,835,925, incorporated by reference herein). The resulting assembly may be laminated to a backplane including pixel electrodes using an electrically conductive adhesive. The assembly may alternatively be attached to one or more segmented electrodes on a backplane, wherein the segmented electrodes are driven directly. The assembly, which may include a non-planar light transmissive electrode material, may also be spray coated with capsules and then overcoated with a back electrode material. (See, e.g., U.S. Patent Publication No. 2021/0132459, incorporated by reference herein.) Alternatively, the electrophoretic fluid may be dispensed directly on a thin open-cell grid that has been arranged on a backplane including an active matrix of pixel electrodes. The filled grid can then be top-sealed with an integrated protective sheet/light-transmissive electrode.

An EPD normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of EPD, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

Electrophoretic media used herein include charged particles that vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention. For example, the electrophoretic medium might include a fluid, a plurality of first and a plurality of second particles dispersed in the fluid, the first and second particles bearing charges of opposite polarity, the first particle being a light-scattering particle and the second particle having one of the subtractive primary colors, and a plurality of third and a plurality of fourth particles dispersed in the fluid, the third and fourth particles bearing charges of opposite polarity, the third and fourth particles each having a subtractive primary color different from each other and from the second particles, wherein the electric field required to separate an aggregate formed by the third and the fourth particles is greater than that required to separate an aggregate formed from any other two types of particles.

The electrophoretic media of the present invention may contain any of the additives used in prior art electrophoretic media as described, e.g., in the E Ink and MIT patents and applications mentioned above. Thus, e.g., the electrophoretic medium of the present invention may include at least one charge control agent to control the charge on the various particles, and the fluid may have dissolved or dispersed therein a polymer having a number average molecular weight in excess of about 20,000 and being essentially non-absorbing on the particles to improve the bistability of the display, as described in the aforementioned U.S. Pat. No. 7,170,670.

Electrophoretic media may use light-scattering particles, typically white, and substantially non-light-scattering particles. There is of course no such thing as a completely light-scattering particle or a completely non-light-scattering particle, and the minimum degree of light scattering of the light-scattering particle, and the maximum tolerable degree of light scattering tolerable in the substantially non-light-scattering particles, used in the electrophoretic of the present invention may vary somewhat depending upon factors such as the exact pigments used, their colors and the ability of the user or application to tolerate some deviation from ideal desired colors. The scattering and absorption characteristics of a pigment may be assessed by measurement of the diffuse reflectance of a sample of the pigment dispersed in an appropriate matrix or liquid against white and dark backgrounds. Results from such measurements can be interpreted according to a number of models that are well-known in the art, e.g., the one-dimensional Kubelka-Munk treatment. The white pigment may exhibit a diffuse reflectance at 550 nm, measured over a black background, of at least 5% when the pigment is approximately isotropically distributed at 15% by volume in a layer of thickness of 1 μm comprising the pigment and a liquid of refractive index less than 1.55. Colored pigments meeting these criteria are hereinafter referred to as “non-scattering” or “substantially non-light-scattering”. Specific examples of suitable particles are disclosed in U.S. Pat. No. 9,921,451, which is incorporated by reference herein. For example, white particles may be formed from an inorganic pigment, such as TiO₂, ZrO₂, ZnO, Al₂O₃, Sb₂O₃, BaSO₄, PbSO₄ or the like, while black particles may be formed from CI pigment black 26 or 28 or the like (e.g., manganese ferrite black spinel or copper chromite black spinel) or carbon black.

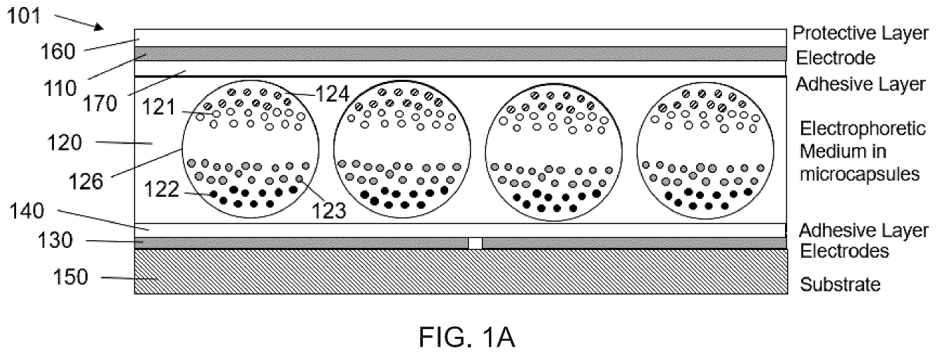

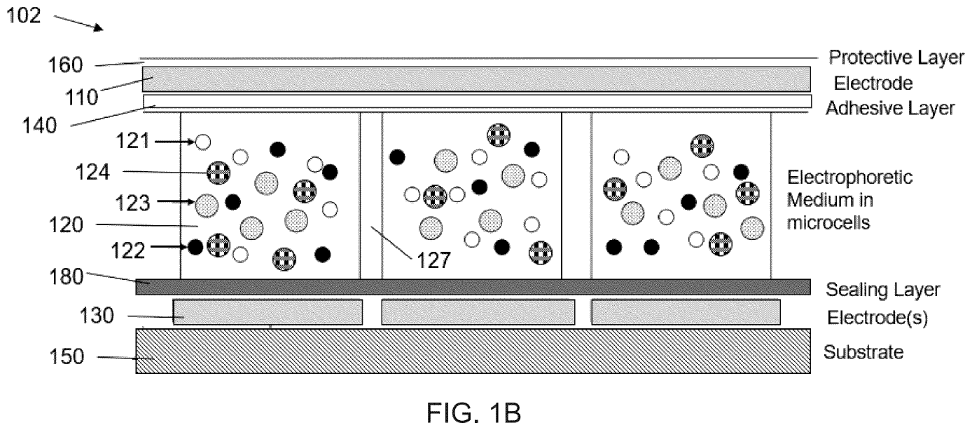

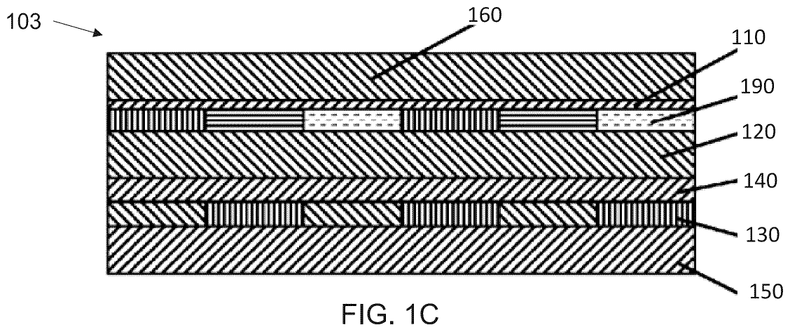

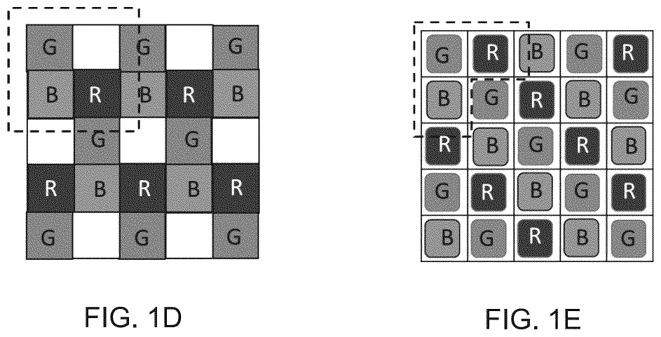

As shown in FIGS. 1A, 1B, and 1C, an EPD 101, 102, 103 typically includes a top transparent electrode 110, an electrophoretic medium 120, and a bottom electrode 130, which is often a pixel electrode of an active matrix of pixels controlled with thin film transistors (TFT). In the electrophoretic media 120 described in FIGS. 1A and 1B, there are four different types of particles, 121, 122, 123, and 124, however more or fewer particle sets can be used with the methods and displays described herein. In the CFA display 103, the electrophoretic medium 120 may include an encapsulated electrophoretic medium with only black and white oppositely-charged particles. FIG. 1D is an exemplary RBGW color filter array pattern that can be incorporated in a CFA display 103. The colored elements 190 may be provided directly at the top transparent electrode 110, which may be, e.g., indium-tin-oxide (ITO). Such CFA films are available from Toppan Printing (Japan). Alternatively, the color filter elements may be applied to the electrophoretic media 120 with an ink-jet or other precision printing process. See, e.g., U.S. Pat. No. 10,209,556. As shown in FIGS. 1D and 1E, the dashed line defines a “pixel” for the purposes of defining a pixel in an image. In FIG. 1D, each pixel of the RGBW CFA includes independently-controllable red, green, and blue subpixels and an equally-sized clear (a.k.a. white) subpixel to improve white and lighter colors in an image. In FIG. 1E, pixel of the RGB CFA includes independently-controllable red, green, and blue subpixel with a portion around each subpixel being clear (a.k.a., partial fill CFA) in order to improve white and light colors in an image. In practice CFA patterns of FIG. 1E are preferred over the patterns of FIG. 1D because each image pixel is slightly smaller and thus a higher resolution can be achieved for the same number of pixel electrodes per inch (PPI), typically between 100 and 400 PPI, more commonly between 150 and 300 PPI.

In FIGS. 1A and 1B, two of the four different types of particle sets, 121, 122, 123, and 124 are of first polarity, while the other two sets are of a second (opposite) polarity. In some electrophoretic media, one of the four different types of particle sets, 121, 122, 123, and 124 is of first polarity, while the other three sets are of a second (opposite) polarity. In some electrophoretic media, two of the four different types of particle sets are of a first polarity, while the other two sets are of an opposite polarity. The electrophoretic medium 120 is typically compartmentalized by, e.g., microcapsules 126 or microcells (separated by walls 127). An optional adhesive layer 140 can be disposed adjacent any of the layers, however, it is typically adjacent an electrode layer 110 or 130. There may be more than one adhesive layer 140 in a given EPD 105, 106, however only one layer is more common. The entire display stack is typically disposed on a substrate 150, which may be rigid or flexible. The display 101, 102 typically also includes a protective layer 160, which may simply protect the top electrode 110 from damage, or it may envelop the entire display 101, 102 to prevent ingress of water, etc. EPDs 101, 102 may also include sealing layers 180 as needed. The adhesive layer 140 may include a primer component to improve adhesion to the electrode layer 110, or a separate primer layer (not shown in FIG. 1B) may be used. The structures of EPDs and the component parts, pigments, adhesives, electrode materials, etc., are described in many patents and patent applications published by E Ink Corporation, such as U.S. 6,922,276; 7,002,728; 7,072,095; 7,116,318; 7,715,088; and 7,839,564, all of which are incorporated by reference herein in their entireties.

In some embodiments, e.g., as shown in FIG. 1A, the EPD may include only a first light-transmissive electrode, an electrophoretic medium, and a second (rear) electrode, which may also be light-transmissive. Each pixel should be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., a select voltage is applied to the selected row electrode to ensure that all the transistors in the selected row are conductive, while a non-select voltage is applied to all other rows so as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode, which is conventionally provided on the opposed side of the electro-optic medium from the non-linear array and extends across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active matrix backplane, however. The driving frames described herein can also be used to refer to a unit of time between updates of, e.g., a singular backplane. While it is possible to drive electrophoretic media with an analog voltage signal, such as produced by a power supply and a potentiometer, the use of a digital controller discretizes the waveform into blocks that are typically on the order of 10 ms, however shorter or longer frame widths are possible. For example, a frame can be 0.5 ms, or greater, such as 1 ms, 5 ms, 10 ms, 15 ms, 20 ms, 30 ms, or 50 ms. In most instances, a frame is less than 100 ms, such 250 ms, 200 ms, 150 ms, or 100 ms. In most applications described herein, the frame is between 5 ms and 30 ms in width, e.g., 8 ms in width. Specialized drive controllers for EPDs are available from, e.g., Ultrachip and Rockchip, however programmable voltage drivers can also be used, such as available from Digi-Key and other electronics components suppliers.

In a conventional EPD using an active matrix backplane, each pixel electrode has associated therewith a capacitor electrode (storage capacitor) such that the pixel electrode and the capacitor electrode form a capacitor; see, e.g., International Patent Publication WO 01/07961. In some embodiments, N-type semiconductor (e.g., amorphous silicon) may be used to from the transistors and the “select” and “non-select” voltages applied to the gate electrodes can be positive and negative, respectively.

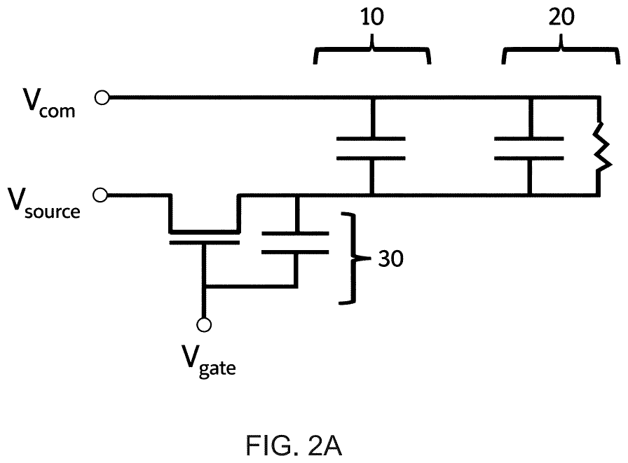

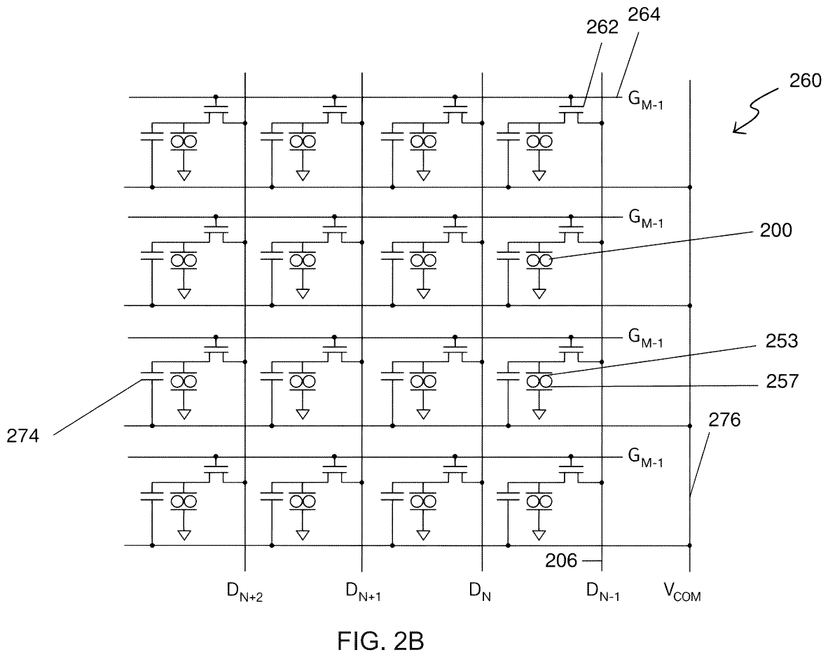

FIG. 2A schematically depicts an exemplary equivalent circuit of a single pixel of an EPD. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts. To compensate for the unwanted “kickback voltage”, a common potential V_{com}, may be supplied to the top plane electrode and the capacitor electrode associated with each pixel, such that, when V_{com} is set to a value equal to the kickback voltage (V_{KB}), every voltage supplied to the display may be offset by the same amount, and no net DC-imbalance experienced.

The TFT array can form an active matrix 260 for image driving, as shown in FIG. 2B. For example, each pixel electrode 253 (corresponding to 130 in FIGS. 1A-1C) is coupled to a thin-film transistor 262 patterned into an array, and connected to gate (row) driver lines 264 and source (column) driver lines 206, running at right angles to the gate drive lines 264. Also, typically, the common (top) light-transparent electrode 257 (corresponding to 110 in FIGS. 1A-1C) has the form of a single continuous electrode while the other electrode or electrode layer is patterned into a matrix of pixel electrodes 253, each of which defines one pixel of the display. An electrophoretic medium 200 is disposed between the pixel electrode 253 and the common electrode 257. Any of the electrophoretic media described above may be used, and while FIG. 2B depicts the electrophoretic medium as contained in microcapsules, microcells, as shown in FIG. 1B, are also suitable. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. The gate scanning rate is typically ~60-150 Hz. When the TFTs 262 are n-type, taking the gate-source voltage positive allows the source voltage to be shorted to the drain. Taking the gate negative with respect to the source causes the drain source current to drop and the drain effectively floats. Because the scan driver acts in a sequential fashion, there is typically some measurable delay in update time between the top and bottom row electrodes. It is understood that the assignment of “row” and “column” electrodes is somewhat arbitrary and that a TFT array could be fabricated with the roles of the row and column electrodes interchanged. Each pixel of the active matrix 260 also includes a storage capacitor 274 as discussed above with respect to FIG. 2A. The storage capacitors 274 are typically coupled to V_{com} line 276. In some embodiments the common light-transparent electrode 257 is coupled to ground, as shown in FIG. 2B. In other embodiments, the common light-transparent electrode 257 is also coupled to V_{com} line 276 (not shown in FIG. 2B).

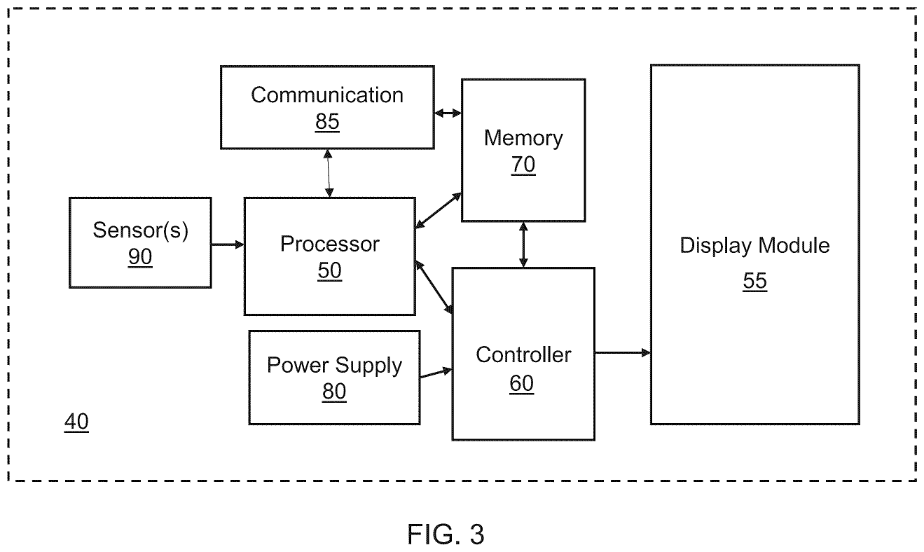

The active matrix 260 described with respect to FIG. 2B (i.e., including the electrophoretic medium 200 and the common light-transparent electrode 257) is typically covered by a protective sheet (e.g., integrated barrier) and sealed to create a display module 55, as shown in FIG. 3. Such a display module 55 becomes the focus of an EPD 40. The EPD 40 will typically include a processor 50, which is configured to coordinate the many functions relating to displaying content on the display module 55, and to transform “standard” images, such as sRGB images to a color regime that best duplicates the image on the display module 55. In some embodiments, the processor 50 performs methods in accordance with various embodiments of the invention including identifying and applying waveforms to select pixel electrodes to reduce blooming artifacts. In other embodiments, some or all of the steps of the invention may be completed by the controller 60. As controller 60 architecture advances, more of the image processing can be embedded into the controller 60 such that an advanced controller can be incorporated into the same package as the display module 55 and pre-programmed with the tools needed to perform method steps in accordance with various embodiments. Advanced controllers for EPDs are available from, e.g., ULTRACHIP and NEXTRONIX.

The processor 50 is typically a mobile processor chip, such as chips made by Freescale or Qualcomm, although other manufacturers are known. The processor 50 is in frequent communication with the non-transitory memory 70, from which it pulls image files and/or lookup tables to perform the color image transformations. The EPD 40 may have more than one non-transitory memory chip. The non-transitory memory 70 may be flash memory. Once the desired image has been converted for display on the display module 55, the specific image instructions are sent to the controller 60, which facilitates voltage sequences being sent to the respective thin film transistors (described above). Such voltages typically originate from one or more power supplies 80, which may include, e.g., a power management integrated chip (PMIC). The EPD 40 may additionally include a communication unit 85, which may implement, e.g., WIFI or BLUETOOTH protocols, and allows the EPD 40 to receive images and instructions, which also may be stored in memory 70. The EPD 40 may additionally include one or more sensors 90, e.g., a temperature sensor and/or a photosensor. Information from the sensors can be fed to the processor 50 to allow the processor to select an optimum lookup table when such lookup-tables are indexed for ambient temperature or incident illumination intensity or spectrum. In some instances, multiple components of the EPD 40 can be embedded in a singular integrated circuit. For example, a specialized integrated circuit may fulfill the functions of processor 50 and controller 60.

### Methods for Reducing Blooming Artifacts

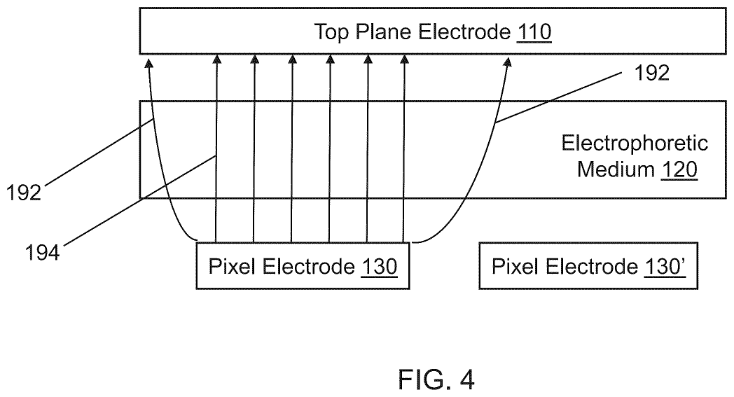

As shown in FIG. 4, inter-pixel coupling can cause portions of the electrophoretic medium 120 above a non-switching pixel electrode 130′ to experience an electric fringe field 192 resulting in some of the electrophoretic medium particles being displaced from their desired position. As a result of inter-pixel coupling, the portion of the electrophoretic medium 120 that is adjacent the pixel electrode 130 that is being updated is unintentionally re-colored. This phenomenon is known as edge ghosting or differential blooming ghosting, and in aggregate can lead to “leftover” images or blooming artifacts after an image update. In addition to showing shapes, the edge ghosting can influence the color that is perceived when one of the non-updating pixel electrodes is a subpixel of a CFA image pixel.

When using a pen or stylus to write primary colors on a CFA based EPD using direct update waveforms, all pixels in a patch of pixels transition to either black or white. If a pixel transitions from white to white or black to black, then that pixel will be “empty” in the waveform lookup table for direct updates. For empty white to white pixels, if at least some neighboring pixels are driven to black (or any other state than white in the case of erasing), then the updating voltage from neighboring pixels will cause fringe fields to be applied to the empty white to white pixel, resulting in blooming artifacts. Blooming artifacts also appear for empty black to black transitions where at least some neighbors are driven to white. This will have an impact on the final color and result in color inconsistency when writing on different backgrounds.

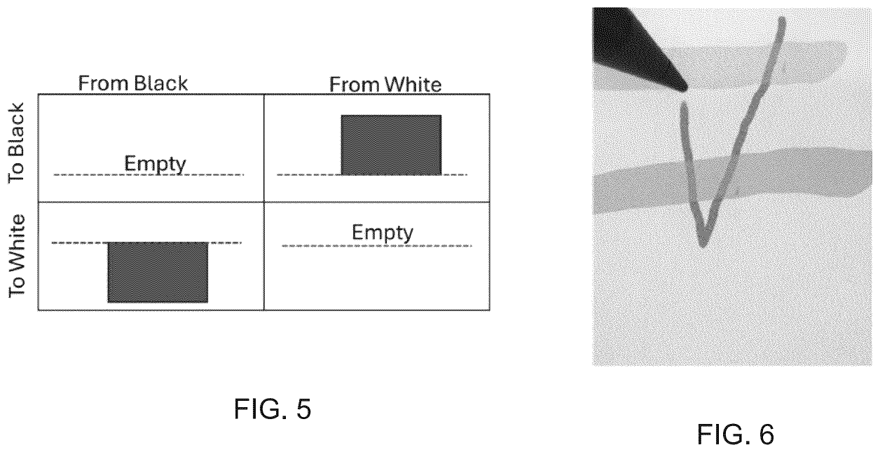

FIG. 5 shows an example of direct update drive waveforms (applied to updating pixel electrodes) in combination with empty black to black or white to white transitions comprising a 0V drive (applied to non-updating pixel electrodes). The figure shows a direct update drive for a white to black transition (top right), a direct update drive for a black to white transitions (bottom left), and empty (0V drives) for white to white empty transitions (bottom right) and black to black empty transitions (top left). Such direct update drives result in a fast and non-flashy primary color pen responses with the tradeoff of color non-uniformity during writing (as shown, e.g., in FIG. 6) and ineffective erasing as a result of blooming artifacts.

Various drive scheme solutions have been used to mitigate differential blooming ghosting by applying additional corrective waveforms. These techniques, however, are generally not suitable for pen writing applications on EPDs where non-flashy and fast updates are highly desirable.

Various embodiments of the invention disclosed herein relate to methods for reducing blooming artifacts in EPDs, including in pen applications, by applying selected non-visible stomps or top-off pulse waveforms to non-updating pixel electrodes to minimize color variation and erase ghosting by urging particles displaced by fringing fields toward their desired original positions. A process for rendering images in accordance with one or more embodiments includes determining the strength of fringe fields affecting each non-updating pixel and selecting an appropriate top-off pulse waveform from a lookup table and applying it to the pixel to reduce blooming effects. Pen color and background history for each pixel can also be monitored for selecting the particular top-off pulses to be applied.

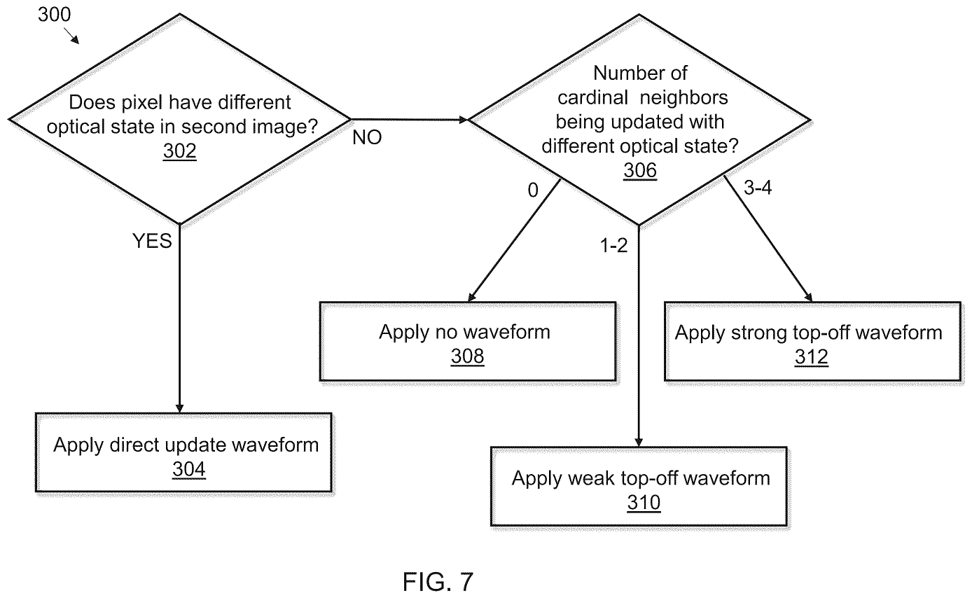

FIG. 7 is a flowchart generally illustrating an exemplary process 300 in accordance with one or more embodiments for reducing blooming artifacts in a second image rendered on an EPD following an initial first image. For each of the display pixels, the process includes, at step 302, determining whether the display pixel has a different optical state in the second image compared to the first image (i.e., if the display pixel is being updated from white to black or from black to white). If the display pixel has a different optical state in the second image, then at step 304 a direct update waveform is selected from a lookup table and applied to the display pixel to update the display pixel to the desired optical state in the second image. If the display pixel has the same optical state in the first and second images (i.e., it is an empty or non-updating pixel), then at step 306, the strength of fringing fields applied to the non-updating pixel from any updating neighboring display pixels is determined. This is done by determining the number of cardinal neighboring pixels that are being updated to have different optical state from the non-updating display pixel in the second image. If there are no such cardinal neighboring pixels, then no waveform is applied at step 308. There are one or two such cardinal neighboring pixels, then a weak top-off waveform is applied to the display pixel at step 310. There are three or four such cardinal neighboring pixels (resulting in a stronger fringing field effect), then a strong top-off waveform is applied to the display pixel at step 312. In one or more embodiments, the steps of the process are performed by a controller 60 and/or a processor 50 configured to drive the display pixels to desired optical states as discussed above in connection with FIG. 3. In one or more embodiments, the steps are completed in less than 500 ms, preferably less than 200 ms, preferably less than 100 ms.

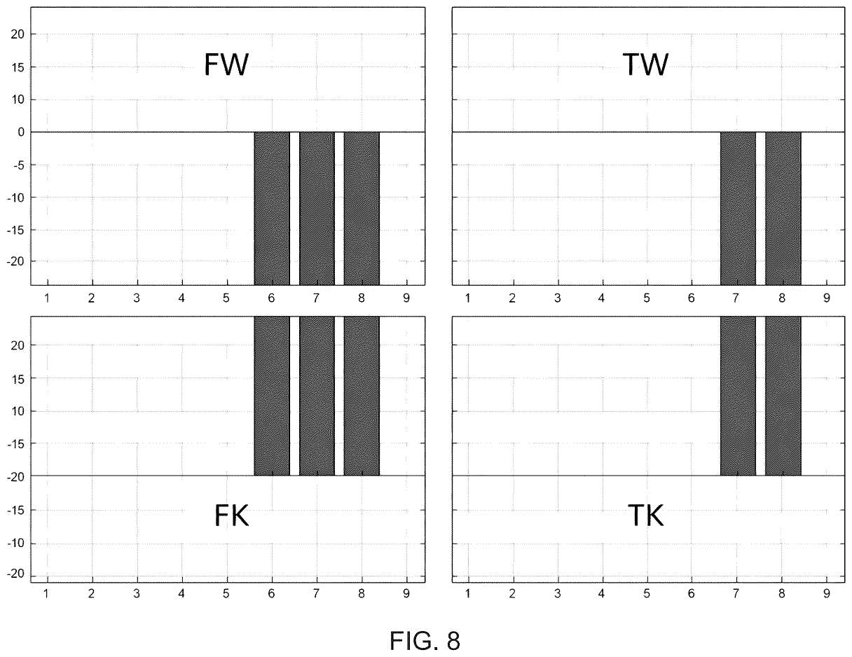

FIG. 8 shows one example of a set of top-off waveforms or transitions that may be applied to non-updating pixels to reduce blooming effects. The top-off waveforms are identified as FK, TK, FW, and TW. FK and FW refer to the strong top-off waveforms for empty black to black and white to white pixels, respectively. TK and TW refer to weak top-off waveforms for empty black to black and white to white pixels, respectively.

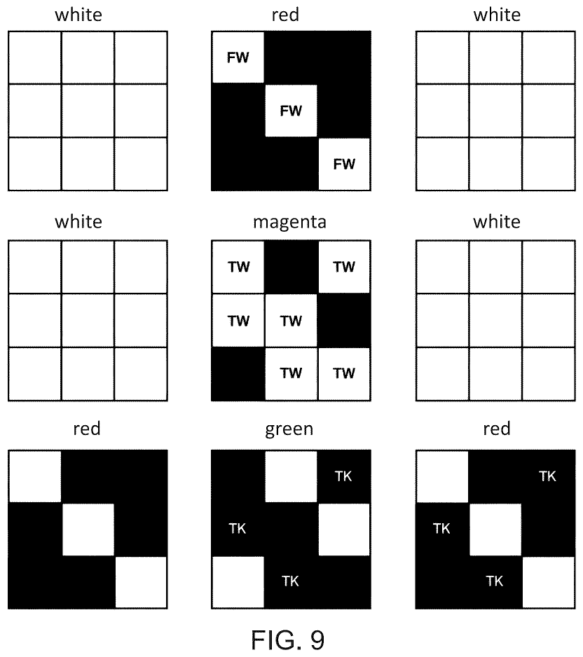

FIG. 9 shows three examples of how appropriate top-off waveforms are selected and applied to reduce blooming artifacts in accordance with one or more embodiments. The figure shows an array of nine pixels that can be switched between black and white in various optical states. In this example, each of the nine pixels corresponds to a subpixel of the CFA subpixel pattern depicted in FIG. 1E. The left column represents the display background color, the middle column represents the writing color (written on the background with a pen), and the right column represents erasing back to the background color. Referring to the first row, when red is written on white, a selected set of 6 of the 9 pixels are updated from white to black. Three of the pixels are not updated and remain white so as to display the color red using the CFA. The pixels that were updated from white to black cause blooming in the three white pixels that were not updated. To counter the blooming effect, a strong FW top-off waveform is applied to each non-updated white pixels. The strong FW top-off waveform is selected (instead of the weak TW top-off waveform or no waveform) because each of the non-updated pixels empty pixel has a high number (four in this case) of lateral or cardinal neighbors that are being driven with a non-zero voltage to a color that is not white. When erasing the written red to white in the third column, no top-off waveform is applied because the black pixels going to white are transitioned to the same color as the pixels that are not updated. In this instance, the fringing fields will actually have a favorable effect.

The second row in FIG. 9 depicts writing magenta on a white background and then erasing the magenta writing. In this case, the blooming effects on the non-updating pixels are weaker than the first row because each non-updated pixels has a lower number (two) of lateral or cardinal neighbors that are being driven to a color that is not white with a non-zero voltage. As a result, a weak TW top-off waveform is applied to the non-updating pixels to counter the blooming effect.

In the third row depicted in FIG. 9, a weak TK top-off waveform is applied to select non-updating black pixels to counter blooming effects caused by neighboring pixels transitioning from black to white.

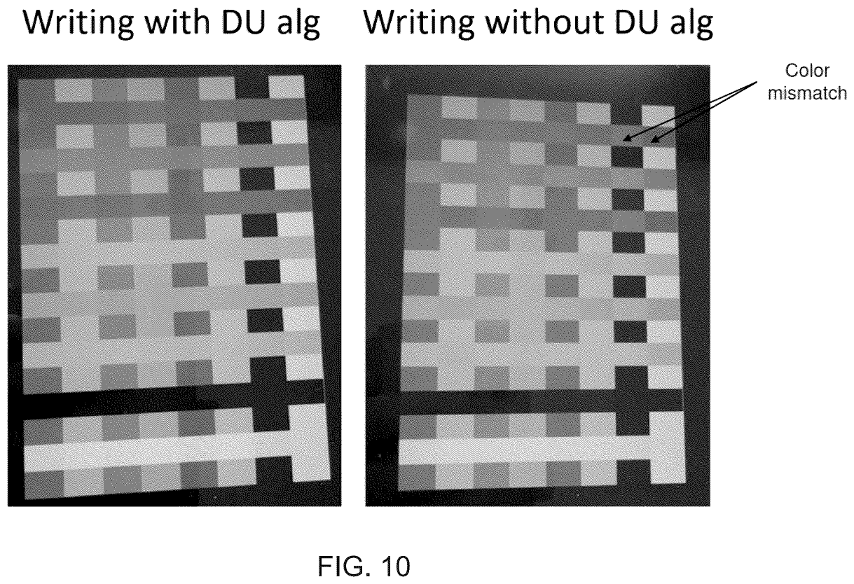

The processes disclosed above in accordance with various embodiments have been found to reduce blooming artifacts and improve color uniformity. FIG. 10 illustrates the results of testing for writing color uniformity in a CFA-based EPD at 25C when writing using direct update drive schemes. The background comprises eight primary colors (red, cyan, green, magenta, blue, yellow, black, and white) in vertical bars, rendered using a GCC drive scheme (317 ms update time) with no empty (i.e., non-updated) pixels. Horizontal bars of eight primary colors were written across the background using direct update drive schemes (100 ms update time), which also had no empty pixels. The left picture in FIG. 10 shows horizontal bars rendered using the process described above in FIG. 7. The right picture was rendered using a conventional writing process. As can be seen, the written colors in the left image are more consistent and uniform in color than the written colors in the right picture, which features multiple areas of color mismatch.

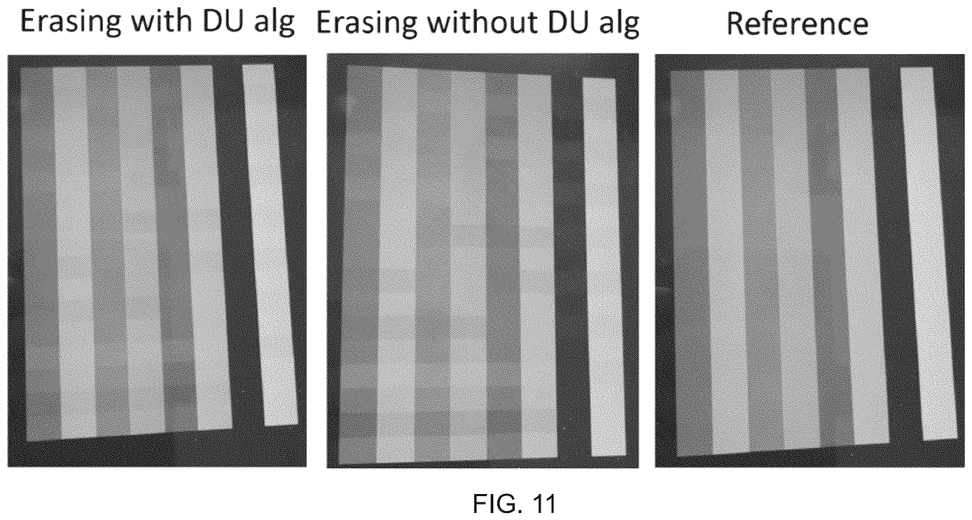

The processes described above in accordance with various embodiments have also been found to reduce ghosting after erasing a written color. FIG. 11 shows the testing results of erasing horizontal bars similar to the horizontal bars depicted in FIG. 10 and reverting to the vertical background colors. The left picture in the figure shows the results of erasing the horizontal bars using direct update drive schemes (100 ms update time) described above in accordance with embodiments of the invention. The middle picture shows the results of erasing the horizontal bars using a conventional erasing process. The right picture shows the vertical bars for reference without having had any horizontal bars written or erased. The left picture shows significantly reduced ghosting compared to the middle picture. It has been found that with careful tuning of the top-off waveforms, ghosting can be further mitigated.

One non-limiting example of pseudo-code illustrating a process for reducing blooming artifacts in accordance with one or more embodiments is provided below.

K=[1, FK, TK], W=[31, FW, TW]

For all pixels (i,j) in any order:
If currPixelWfmState and nextPixelWfmState is any(K), then KKpixel is TRUE else FALSE
If currPixelWfmState and nextPixelWfmState is any(W), then WWpixel is TRUE else FALSE
If nextPixelWfmState is !any(K), then notToKPixel is TRUE else FALSE
If nextPixelWfmState is !any(W), then notToWPixel is TRUE else FALSE
If notToWPixel is True and KKpixel is FALSE, then notToWpixelWithoutKtoK is TRUE else FALSE
If notToKPixel is True and WWpixel is FALSE, then notToKpixelWithoutWtoW is TRUE else FALSE
If WWpixel is TRUE, AND
If at least FWT cardinal neighbors are notToKpixelWithoutWtoW, then apply FW-transition
   Else apply TW-transition
If KKpixel is TRUE, AND
If at least FKT cardinal neighbors are notToWpixelWithoutKtoK, then apply FK-transition
   Else apply TK-transition
End

In one exemplary embodiment, FWT in the pseudo-code above is equal to 3. However, this value can changed depending on the EPD design, including properties of the thin film transistors used with the pixel electrodes.

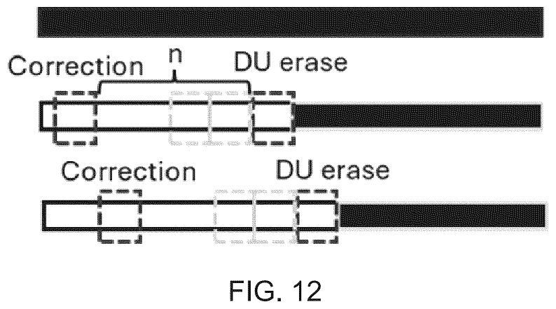

In the illustrative embodiments disclosed above, the corrective waveforms with top-off pulses are applied in real time during pen writing and erasing events in the empty pixels. In one or more further embodiments, the corrective waveforms with top-off pulses can also be applied as part of a non-visible second update trailing the first pen writing and erasing update to avoid any latency as depicted, e.g., in FIG. 12. For example, the corrective waveforms can be applied a few frames after adjacent pixels are transitioned. In one example, for an erasing process, the corrective waveforms are applied after each patch of erasing while the user's pen is still engaging the display erasing other patches. This process also effectively erases ghost or blooming artifacts in a non-flashy and direct manner.

The processes described above in connection with various embodiments of the invention thereby effectively achieve target colors and provide low ghost erase for pen application by utilizing corrective waveforms with top-off pulses optimized for various combinations of pen and background colors. The processes achieve short update times with low flashiness for pen usage, eliminating the need for driving or refreshing the pen writing or background using a full flash update. The non-visible corrective pulses can be applied during pen or erase events or thereafter as a non-visible second update. The process identifies what transitions should be applied based on the content of the pixel and neighboring pixels.

The processes are particularly suited for CFA-based electrophoretic devices providing effective pen writing and erasing with uniform color and low ghosting.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

1. A method of rendering images on a color filter array (CFA) based electrophoretic display including an electrophoretic medium layer superposed on a backplane array of electrodes, each of said electrodes being independently addressable to apply driving waveforms to an adjacent portion of the electrophoretic medium layer to drive such portion of the electrophoretic medium layer between a first substantially white optical state and a second substantially black optical state thereby forming an array of black and white display pixels in the electrophoretic medium, said display also including a CFA superposed on the electrophoretic medium layer, said CFA comprising an array of CFA pixels, each of said CFA pixels comprising at least three CFA subpixels, each of said at least three CFA subpixels having a different color, each CFA subpixel being in registered alignment with a different one of the display pixels such that the color of any CFA subpixel is visible to a viewer when the display pixel in registered alignment with that CFA subpixel is in the substantially white optical state, and wherein the color of any CFA subpixel in registered alignment with a display pixel in the substantially black optical state is not visible to the viewer or is less visible to the viewer than the color of a CFA subpixel in registered alignment with a display pixel in the substantially white optical state; the method comprising the steps of:
(a) rendering a first image on the display wherein each of the display pixels have a selected optical state; and
(b) rendering a subsequent second image on the display in which a first subset of the display pixels has the same optical states as in the first image and a second subset of the display pixels has different optical states than in the first image by:
(i) applying a selected direct update waveform to each display pixel in the second subset of display pixels to update the optical state of said display pixel; and
(ii) determining a strength of any fringe field applied to each display pixel in the first subset of display pixels resulting from updating of adjacent display pixels in the second subset of display pixels, and selecting and applying a top-off waveform to said display pixel having a strength generally commensurate with the strength of the fringe field to reduce blooming artifacts from the fringe field.

2. The method of claim 1, wherein determining a strength of any fringe field applied to each display pixel in the first subset of display pixels comprises determining the number of cardinal neighboring display pixels in the second subset of display pixels having a different optical state in the second image than said display pixel.

3. The method of claim 1, wherein step (ii) comprises applying a selected top-off waveform to each display pixel in the first subset of display pixels that has at least one cardinal neighboring display pixel in the second subset of display pixels having a different optical state in the second image than said display pixel to reduce blooming artifacts in said display pixel; and applying no waveform to remaining display pixels in the first subset of display pixels.

4. The method of claim 1, wherein each direct update waveform comprises a given number of voltage pulses having a given amplitude, and wherein each top-off waveform has the same given amplitude and a smaller number of voltage pulses than the given number of voltage pulses of the direct update waveforms.

5. The method of claim 1, wherein the images are rendered at least in part in response to a stylus writing or erasing input to the electrophoretic display.

6. The method of claim 1, wherein steps (a) and (b) are performed by a controller and/or a processor configured to drive the display pixels to desired optical states.

7. The method of claim 1, further comprising retrieving the direct update waveforms and the top-off waveforms from one or more lookup tables stored in a memory.

8. The method of claim 1, wherein steps (i) and (ii) are completed in less than 500 ms, preferably less than 200 ms, preferably less than 100 ms.

9. The method of claim 1, wherein the colors of the CFA subpixels include red, green, and blue.

10. The method of claim 1, wherein steps (i) and (ii) are performed in real time during pen writing and erasing events.

11. The method of claim 1, wherein step (ii) is performed a plurality of frames after step (i).

12. The method of claim 11, wherein step (ii) is performed during an erasing operation with a pen while the pen is engaging the CFA based electrophoretic display.

13. A color filter array (CFA) based electrophoretic display, comprising:
an electrophoretic medium layer having a viewing side for facing a viewer;
a light-transmissive electrode on the viewing side of the electrophoretic medium layer;
a backplane array of electrodes superposed on a side of the electrophoretic medium layer opposite the viewing side, each of said electrodes being independently addressable to apply driving waveforms to an adjacent portion of the electrophoretic medium layer to drive such portion of the electrophoretic medium layer between a first substantially white optical state and a second substantially black optical state thereby forming an array of black and white display pixels in the electrophoretic medium;
a CFA superposed on the electrophoretic medium layer, said CFA comprising an array of CFA pixels, each of said CFA pixels comprising at least three CFA subpixels, each of said at least three CFA subpixels having a different color, each CFA subpixel being in registered alignment with a different one of the display pixels such that the color of any CFA subpixel is visible to a viewer when the display pixel in registered alignment with that CFA subpixel is in the substantially white optical state, and wherein the color of any CFA subpixel in registered alignment with a display pixel in the substantially black optical state is not visible to the viewer or is less visible to the viewer than the color of a CFA subpixel in registered alignment with a display pixel in the substantially white optical state; and
a control system coupled to the light-transmissive electrode and the backplane array of electrodes, said control system including a controller and/or a processor configured to:
(a) render a first image on the display wherein each of the display pixels have a selected optical state; and
(b) render a subsequent second image on the display in which a first subset of the display pixels has the same optical states as in the first image and a second subset of the display pixels has different optical states than in the first image by (i) applying a selected direct update waveform to each display pixel in the second subset of display pixels to update the optical state of said display pixel; (ii) determining a strength of any fringe field applied to each display pixel in the first subset of display pixels resulting from updating of adjacent display pixels in the second subset of display pixels, and selecting and applying a top-off waveform to said display pixel having a strength generally commensurate with the strength of the fringe field to reduce blooming artifacts from the fringe field.

14. The CFA based electrophoretic display of claim 13, wherein determining a strength of any fringe field applied to each display pixel in the first subset of display pixels comprises determining the number of cardinal neighboring display pixels in the second subset of display pixels having a different optical state in the second image than said display pixel.

15. The CFA based electrophoretic display of claim 13, wherein step (ii) comprises applying a selected top-off waveform to each display pixel in the first subset of display pixels that has at least one cardinal neighboring display pixel in the second subset of display pixels having a different optical state in the second image than said display pixel to reduce blooming artifacts in said display pixel; and applying no waveform to remaining display pixels in the first subset of display pixels.

16. The CFA based electrophoretic display of claim 13, wherein each direct update waveform comprises a given number of voltage pulses having a given amplitude, and wherein each top-off waveform has the same given amplitude and a smaller number of voltage pulses than the given number of voltage pulses of the direct update waveforms.

17. The CFA based electrophoretic display of claim 13, further comprising a memory, and wherein the controller and/or a processor is further configured to retrieve the direct update waveforms and the top-off waveforms from one or more lookup tables stored in the memory.

18. The CFA based electrophoretic display of claim 13, wherein steps (i) and (ii) are completed in less than 500 ms, preferably less than 200 ms, preferably less than 100 ms.

19. The CFA based electrophoretic display of claim 13, wherein steps (i) and (ii) are performed in real time during pen writing and erasing events.

20. The CFA based electrophoretic display of claim 13, wherein step (ii) is performed a plurality of frames after step (i) or wherein step (ii) is performed during an erasing operation with a pen while the pen is engaging the CFA based electrophoretic display.
